(19) United States
(12) Patent Application Publication
(10) Pub. No.: US 2009/0172388 A1
(43) Pub. Date: Jul. 2, 2009

(54) PERSONAL GUARD

(75) Inventor: Moshe Maor, Santa Clara, CA (US)

Correspondence Address: INTEL CORPORATION;c/o CPA Global, P.O. BOX 52050, MINNEAPOLIS, MN, 55402, US

(73) Assignee: INTEL CORPORATION, Santa Clara, CA (US)

(21) Appl. No.: 11/967,960

(22) Filed: Dec. 31, 2007

(51) Int. Cl. H04L 9/00

(52) U.S. Cl. 713/150; 713/189

(57) ABSTRACT

In some embodiments data input to an input device is encrypted before it is received by any software. Other embodiments are described and claimed.

### RELATED APPLICATIONS

This application is related to the following applications filed on the same date as this application:
“Management Engine Secured Input” to Moshe Maor, Attorney Docket Number P25460;
“Personal Vault” to Moshe Maor, Attorney Docket Number P26881;
“Secure Input” to Douglas Gabel and Moshe Maor, Attorney Docket Number P26882;
“Secure Client/Server Transactions” to Moshe Maor, Attorney Docket Number P26890.

### TECHNICAL FIELD

The inventions generally relate to a personal guard.

### BACKGROUND

Many different types of keyloggers currently exist to allow hackers to hook into different layers in the software stack of a user's computer. The hooking point can be as low (that is, as close to the hardware) as a keyboard base driver or as high (that is, as far from the hardware) as a script that runs inside the scope of an internet browser. In this manner, software based keyloggers and other types of malware may be used by a hacker to hijack sensitive information that a user types into a computer. Therefore, a need has arisen to protect a user's sensitive information from a hacker using keyloggers and other types of malware.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a system according to some embodiments of the inventions.

FIG. 3 illustrates a system according to some embodiments of the inventions.

FIG. 4 illustrates a sequence diagram according to some embodiments of the inventions.

FIG. 5 illustrates a graphic representation according to some embodiments of the inventions.

### DETAILED DESCRIPTION

Some embodiments of the inventions relate to a personal guard.

In some embodiments data input to an input device is encrypted before it is received by any software.

In some embodiments a controller is to encrypt data input to an input device before it is received by any software.

In some embodiments a secure path is provided between an input device and a controller and a secure path is provided between the controller and a remote server.

In some embodiments a controller is to provide a secure path between an input device and the controller. The controller is also to provide a secure path between the controller and a remote server.

In some embodiments a system includes a computer and a remote server. The computer includes an input device and a controller. The controller is to provide a secure path between the input device and the controller. The controller and the server interact to provide a secure path between the controller and the server.

In some embodiments an article (such as a tangible physical article) includes a computer readable medium having instructions thereon which when executed cause a computer to encrypt data input to an input device before it is received by any software.

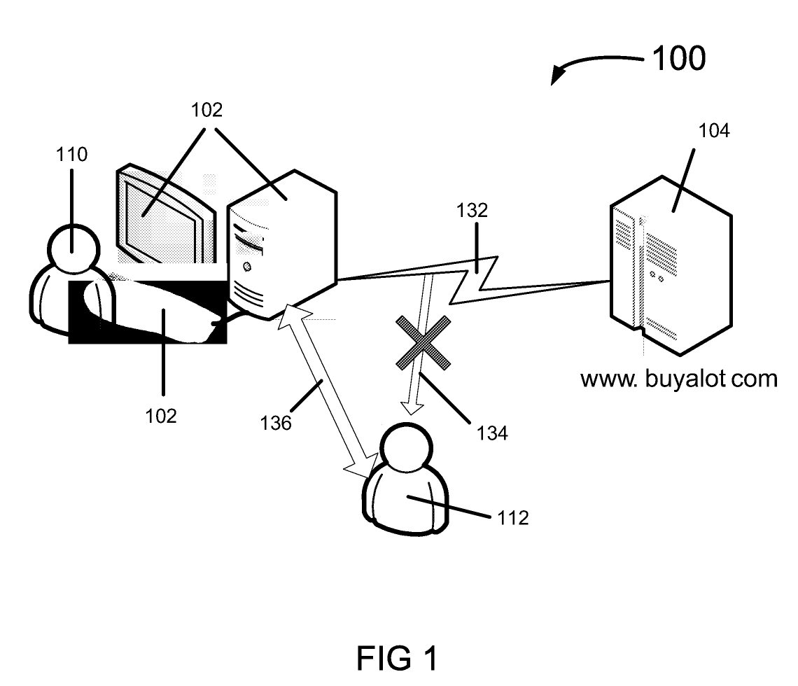

FIG. 1 illustrates a system 100 according to some embodiments. In some embodiments system 100 includes a computer 102 and a remote server 104. FIG. 1 illustrates how an end user 110 (for example, an on-line purchaser of goods and/or services) that is doing some on-line shopping using the computer 102 that is connected to the remote server 104 (for example, via the internet) may be open to attacks from a hacker 112. In the on-line shopping example, a common scenario might include the following numbered steps:

1. The end user 110 is using an internet browser loaded on computer 102 to surf in an e-commerce web site to choose good for purchase (for example, via a remote server 104 of a “www.buyalot.com” web site)
2. The user 110 picks some goods from the “www.buyalot.com” web site and places them into a virtual basket
3. At some point when the user 110 has finished choosing goods for purchase, the user hits a checkout button
4. The e-commerce server 104 opens a form in a window for the user 110 and asks for the user to enter payment information in the form
5. The user 110 types sensitive data into fields of the form such as, for example, a credit card number, phone number, full name, address, etc.
6. The e-commerce server 104 sends back a receipt to the user

During the most sensitive portions of the exemplary scenario discussed above (for example, during steps 4 and 5), the communication between the internet browser of the user 110 and the server 104 of the remote site is typically run on top of a secured connection 132 such as a secure socket layer (SSL) and/or a transfer layer security (TLS), for example. This precludes any adversary such as hacker 112 on the internet that wishes to capture the sensitive data entered by the user from obtaining that data without first breaking cryptographic algorithms used by the secured connected (that is, SSL and/or TLS cryptographic algorithms). This is not typically a problem due to a very high computation complexity that would be required by the hacker 112. Arrow 134 illustrates an attempt by hacker 112 to obtain information via this method. An “X” is included over arrow 134 to illustrate the extreme difficulties in attempting this type of theft attempt.

The typical user 110 is normally aware of the fact that some protection is necessary in order to avoid theft of personal information entered in such a scenario. For example, most users know to look for a special icon normally displayed on a control line of the internet browser that indicates that the current session is being executed over a secured connection. However, a sophisticated hacker 112 may attempt to steal the sensitive information using a completely different approach that is not protected by using a secured connection 132 such as SSL or TLS. For example, in some embodiments, hacker 112 may use a keylogger or other malware to obtain the sensitive information, as illustrated via arrow 136 in FIG. 1. Many different types of keyloggers and/or other malware are currently available, and have the ability to hook into different layers in the software stack running on computer 102, for example. The hooking point for the keyloggers and/or malware can be as low (that is, closer to the hardware) as a keyboard base driver or as high (that is, further from the hardware) as a script that runs inside the scope of the internet browser running on computer 102, for example. Therefore, while it is very important to mitigate network theft attacks on the sensitive data, it is not enough to entirely mitigate theft attacks of sensitive data (resulting, for example, in identity theft).

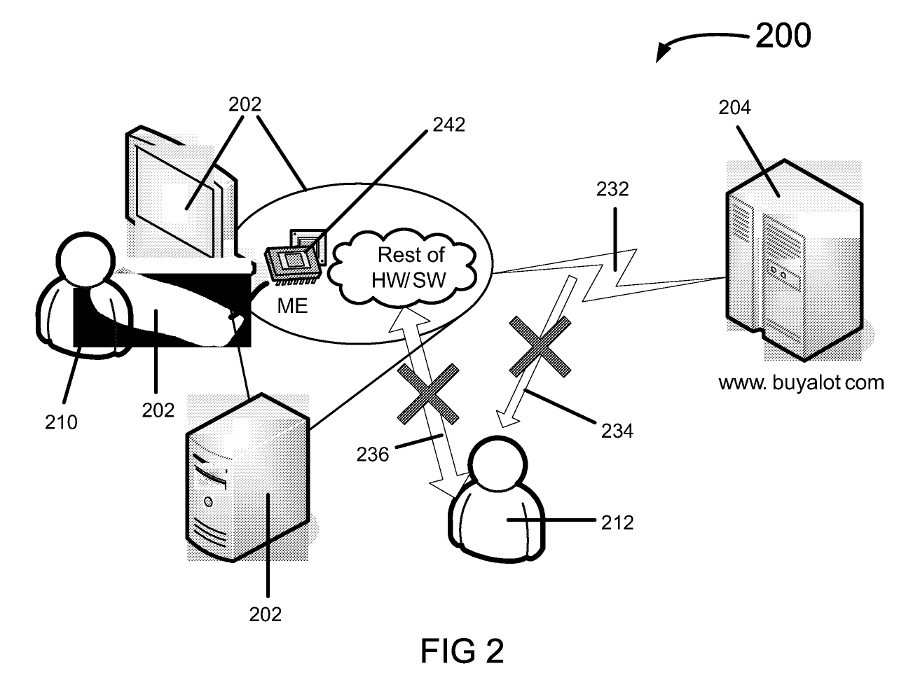

FIG. 2 illustrates a system 200 according to some embodiments. In some embodiments system 200 includes a computer 202 and a remote server 204. FIG. 2 illustrates how an end user 210 (for example, an on-line purchaser of goods and/or services) that is doing some on-line shopping using the computer 202 that is connected to the remote server 204 (for example, via the internet) may guard from attacks from a hacker 212. Similar to the arrangement described in reference to FIG. 1, the communication between the internet browser of the user's computer 202 and the server 204 of the remote site is typically run on top of a secured connection 232 such as a secure socket layer (SSL) and/or a transfer layer security (TLS), for example. This precludes any adversary such as hacker 212 on the internet that wishes to capture the sensitive data entered by the user from obtaining that data without first breaking cryptographic algorithms used by the secured connected (that is, SSL and/or TLS cryptographic algorithms).

Computer 202 includes a management engine (and/or manageability engine and/or ME). In some embodiments, ME 242 is a micro-controller and/or an embedded controller. In some embodiments, ME 242 is included in a chipset of computer 202. In some embodiments, ME 242 is included in a Memory Controller Hub (MCH) of computer 202. In some embodiments, ME 242 is included in a Graphics and Memory Controller Hub of computer 202.

In some embodiments, ME 242 may be implemented using an embedded controller that is a silicon-resident management mechanism for remote discovery, healing, and protection of computer systems. In some embodiments, this controller is used to provide the basis for software solutions to address key manageability issues, improving the efficiency of remote management and asset inventory functionality in third-party management software, safeguarding functionality of critical agents from operating system (OS) failure, power loss, and intentional or inadvertent client removal, for example. In some embodiments, infrastructure supports the creation of setup and configuration interfaces for management applications, as well as network, security, and storage administration. The platform provides encryption support by means of Transport Layer Security (TLS), as well as robust authentication support.

In some embodiments the ME is hardware architecture resident in firmware. A micro-controller within a chipset graphics and memory controller hubs houses Management Engine (ME) firmware, which implements various services on behalf of management applications. Locally, the ME can monitor activity such as the heartbeat of a local management agent and automatically take remediation action. Remotely, the external systems can communicate with the ME hardware to perform diagnosis and recovery actions such as installing, loading or restarting agents, diagnostic programs, drivers, and even operating systems.

Personal guard technology included in system 200 can be used to completely mitigate any attempted attacks from keyloggers and other types of malware. In some embodiments, management engine (and/or manageability engine and/or ME) 242 included within computer 202 takes control over the keyboard of the computer 202 and sets up a trusted path between the user 210 and the ME 242 via any input devices of computer 202 such as the keyboard. Additionally, the ME 242 sets up a secured path (although not a direct connection) between the ME 242 and the remote server 204.

When funneling the sensitive data via the ME 242, the ME 242 actually encrypts the sensitive data that the user 210 types, for example, before the software running on computer 202 obtains the data (for example, sensitive data such as credit card numbers, phone numbers, full name, addresses, etc.) In this manner, when the software that runs on the host processor, for example, of computer 202 is handling the data it is already encrypted and is therefore not usable for keyloggers in an attempt to steal the data via arrow 236 by the hacker 212. Therefore, no matter what type of keylogger is able to infiltrate computer 202 and is currently running on the host processor of computer 202 as part of the software stack, the sensitive data of the user 210 is kept secret when personal guard operations (for example, via ME 242) are being used while user 210 is typing the data.

FIG. 2 has described using personal guard operations to mitigate hacker attempts such as keyloggers from stealing sensitive data entered by a user. However, it is recognized that a management engine such as ME 242 of FIG. 2 is not necessary for all embodiments, and that other devices may be used to implement the same types of operations as described herein. Additionally, an Intel branded ME and/or Intel AMT is not necessary for all embodiments, and other devices may be used to implement the same types of operations as described herein.

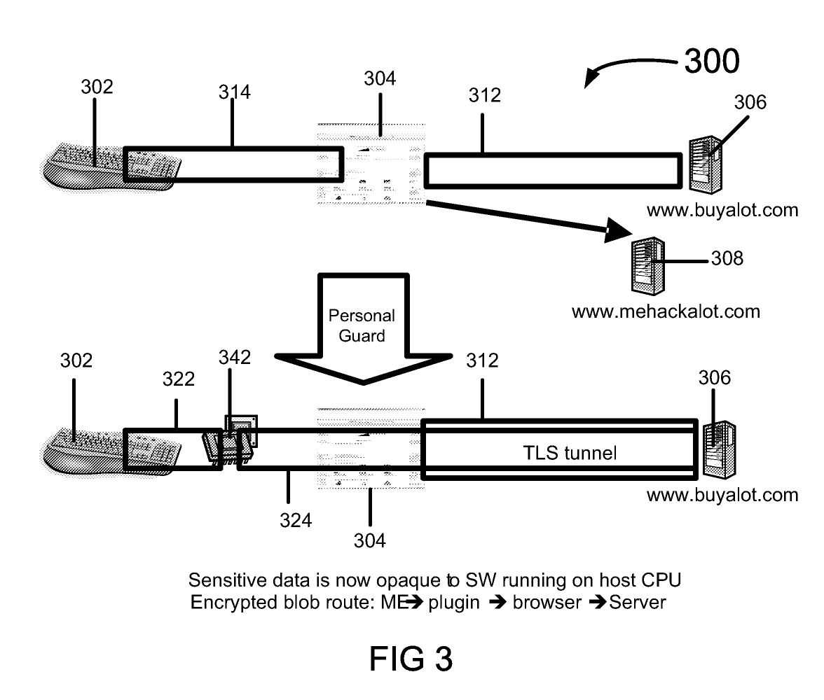

FIG. 3 illustrates a system 300 according to some embodiments. In some embodiments system 300 includes an input device 302 (for example, a keyboard, a mouse, and/or any other type of input device), an Operating System (OS) and/or internet browser 304, a remote server 306, and a hacker (and/or a hacker computer) 308. FIG. 3 illustrates a difference between a system that is guarded by internet based encryption such as SSL or TLS in the top portion of FIG. 3 and a system that is guarded with personal guard technology in a bottom portion of FIG. 3. In the top portion of FIG. 3 a secured connection 312 (for example, using SSL and/or TLS and/or tunneling technology) occurs between the OS/internet browser 304 and the remote server 306, and software based input/output 314 occurs between input device 302 and the OS/internet browser 304. In the scenario illustrated at the top of FIG. 3, the hacker 308 can use malware and/or keyloggers to intercept and make use of sensitive data input by a user. In the bottom of FIG. 3, on the other hand, a secured connection 322 is provided between a portion 342 of a user computer (for example, such as a Management Engine or ME) and the OS/internet browser 304 using personal guard technology according to some embodiments, for example. Additionally, sensitive data is encrypted at 324 between the portion 342 (such as an ME) and the remote server 306 using personal guard technology according to some embodiments, for example. In this manner, software based keyloggers and other types of malware may not be used to hijack sensitive information input by a user at input device 302.

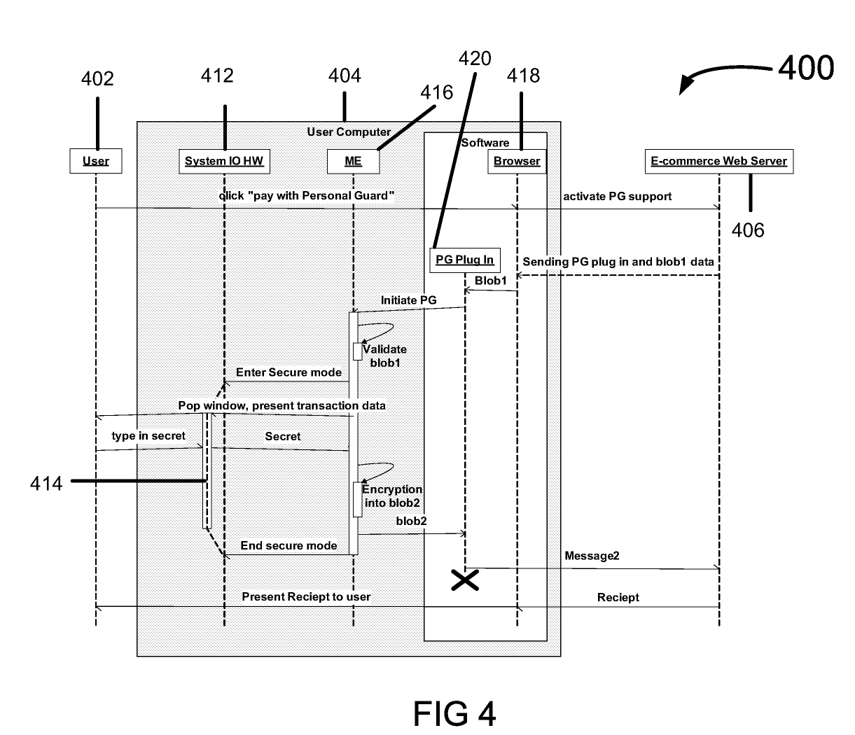

FIG. 4 illustrates a sequence diagram 400 according to some embodiments. Sequence diagram 400 includes a user 402, a computer 404 of the user 402, and a server (for example, an e-commerce web server) 406. Computer 404 includes system input/output hardware (system I/O HW) 412, an input device (for example, a keyboard and/or a mouse) 414, a management engine (and/or manageability engine and/or ME) 416, a browser 418, and a plug in 420. The system I/O HW 412, the input device 414, and the ME 416 are all implemented, for example, in hardware and/or firmware and the browser 418 and the plug in 420 are all implemented, for example, in software. User 402 is a person who is using computer 404 to browse a remote site for which secured input is desired. The user 402 wishes to secure the input using personal guard technology in order to send sensitive information (for example, as part of a transaction) to the remote server 406. System I/O HW 412 is core I/O control implementation within the computer 404 being used by user 402. It is implemented, for example, in the chipset of the computer 404, and includes modules that support secured input and secured output. The input device 414 is an external hardware device through which the user 402 enters sensitive data (for example, by typing in the sensitive data on a keyboard). The ME 416 is also included, for example, in the chipset of the computer 404 of the user 402 and controls the secured I/O flows of the system I/O HW and implements (for example, in firmware) the main personal guard flow. The browser 418 is the software that the user 402 normally executes on the computer 404 to browse web sites on the internet. It is noted that personal guard technology according to some embodiments may be used to harden the secured login, for example, of other internet technologies, so a web browser is just an example and is not required in some embodiments. Plug in 420 is a browser plug in used to convey data between the ME 416 (and/or personal guard firmware application) and the remote server 406. The remote server 406 (for example, an e-commerce web server) is a server with which the user 402 is executing some transactions. The server 406 is aware of the personal guard technology being used by the ME 416 and is therefore able to take advantage of secured transactions.

In some embodiments the user 402 clicks a selection such as “pay with Personal Guard” and the browser software 418 then activates Personal Guard support with the server 406. Server 406 then sends a Personal Guard plug in and data (for example, “blob1”) to the Personal Guard plug in 420 via the browser 418. Plug in 420 then sends an “initiate Personal Guard” signal to the ME 416, which then validates the data (“blob1”), and causes the user computer 404 to enter a secure mode, causing a pop up window to be displayed to the user 402 in which the user can securely enter sensitive and/or secret data. User 402 enters this data via input device 414 secretly and securely, and the ME 416 encrypts the data (for example, into “blob2”). The encrypted data is then sent via the browser 418 and/or plug in 420 software to the server 406 (for example, as “message2”). The server 406 sends a receipt back to the computer 404, which is presented to the user 402. In this manner any sensitive and/or secret data input by the user 402 to the server 406 via computer 404 is securely transmitted, and software based keyloggers and/or any other types of malware are not able to hijack any of the input data.

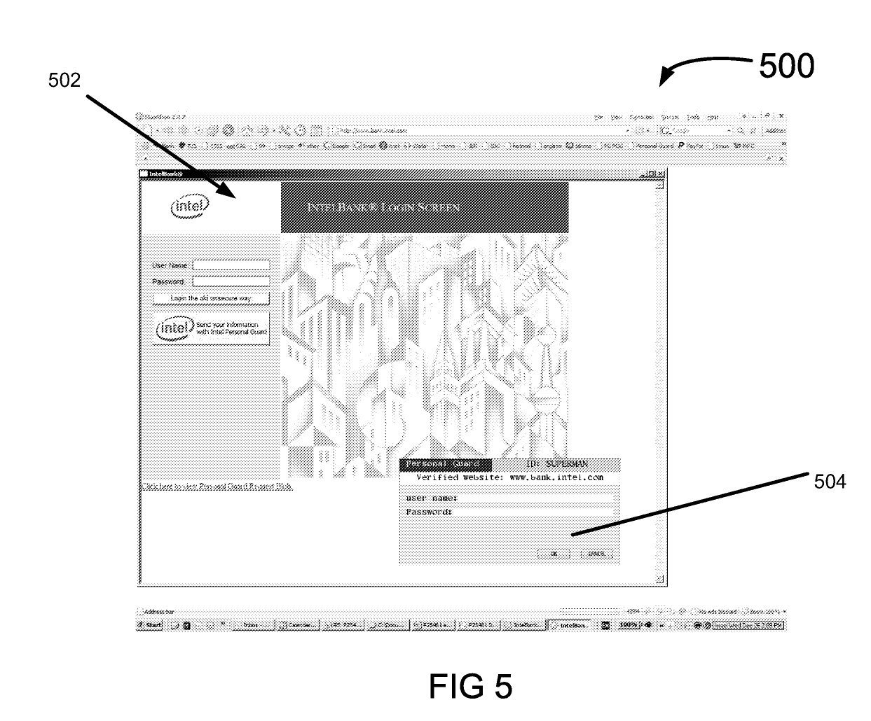

FIG. 5 illustrates a graphic representation 500 according to some embodiments. Graphic representation 500 includes a web site 502 of a vendor (for example, such as a bank or a web site shopping site, etc.) A special Personal Guard login may be used in addition to or instead of the typical web site login. A personal guard window 504 is output on the screen over or beside the web site display, for example, by an ME as secured graphics output through which a user communicates with the ME to convey sensitive information (such as credit card numbers, login credentials, a password to login to a web site, phone number, full name of user, address, social security numbers, etc.)

A personal guard plug-in triggers the ME to show the personal guard window 504. Window 504 cannot be captured by software running on the CPU, for example. When data is encrypted by the ME, it is sent to the server of the web site (for example, a bank web site as shown in FIG. 5). The server of the web site is the only one who can decrypt the data and obtain the ID and/or passcode data, for example. The window 504 includes, for example, a special ID that ensures a user that the ME drew that window (for example, “ID: superman”), an animation (for example, “A” at top left of window 504) that runs when user input goes into the ME, an explicit URL of the remote server to help mitigate address-bar spoofing, which is the number one phishing technique of hackers (for example, in FIG. 5 “www.bank.intel.com”), user credentials such as ID, passcode, etc. stored in secured storage of the ME so that a user does not need to type the data every time (after the initial ME login). The secured input allows the user to enter and manipulate the data, and user data may be clearly shown in window 504 or fully or partially blocked by using, for example, “********”, but in any case whether the data is shown or not shown in window 504 it cannot be read by any software application running on the user's computer or by a hacker trying to use keylogger software and/or other malware.

Although some embodiments have been described herein as being implemented in a particular manner, according to some embodiments these particular implementations may not be required. For example, although some embodiments have been described as using an ME, other embodiments do not require use of an ME.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus comprising:
a controller to provide a secure path between an input device and the controller and to provide a secure path between the controller and a remote server.

2. The apparatus of claim 1, wherein the controller is located in a chip set of a computer.

3. The apparatus of claim 1, wherein the controller is a management engine.

4. The apparatus of claim 1, the controller to encrypt software running on a computer in which the controller is included.

5. The apparatus of claim 1, the controller to encrypt data on the secure path between the input device and the controller.

6. The apparatus of claim 1, the controller to encrypt data input to the input device before it is received by any software.

7. A method comprising:
providing a secure path between an input device and a controller; and
providing a secure path between the controller and a remote server.

8. The method of claim 7, further comprising encrypting data between the input device and the controller.

9. The method of claim 7, further comprising encrypting data input to the input device before it is received by any software.

10. A system comprising:
a computer including an input device and a controller, the controller to provide a secure path between the input device and the controller; and
a server remote from the computer;
wherein the controller and the server interact to provide a secure path between the controller and the server.

11. The system of claim 10, wherein the controller is located in a chip set of the computer.

12. The system of claim 10, wherein the controller is a management engine.

13. The system of claim 10, wherein the controller to encrypt software running on the computer.

14. The system of claim 10, the controller further to encrypt data on the secure path between the input device and the controller.

15. The system of claim 10, the controller further to encrypt data input to the input device before it is received by any software.

16. An apparatus comprising:
a controller to encrypt data input to an input device before it is received by any software.

17. The apparatus of claim 16, the controller to provide a secure path between the input device and the controller.

18. The apparatus of claim 16, wherein the controller is located in a chip set of a computer.

19. The apparatus of claim 16, wherein the controller is a management engine.

20. The apparatus of claim 16, the controller to encrypt software running on a computer in which the controller is included.

21. The apparatus of claim 16, the controller to provide a secure path between the input device and the controller and the controller to encrypt data on the secure path between the input device and the controller.

22. A method comprising:
encrypting data input to an input device before it is received by any software.

23. The method of claim 22, further comprising providing a secure path between an input device and a controller.

24. The method of claim 23, further comprising encrypting data between the input device and the controller.

25. An article comprising:
a computer readable medium having instructions thereon which when executed cause a computer to:
encrypt data input to an input device before it is received by any software.

26. The article of claim 25, the computer readable medium further having instructions thereon which when executed cause a computer to provide a secure path between an input device and a controller.

27. The article of claim 26, the computer readable medium further having instructions thereon which when executed cause a computer to encrypt data between the input device and the controller.
